(19) United States
(12) Patent Application Publication
(10) Pub. No.: US 2024/0010811 A1
(43) Pub. Date: Jan. 11, 2024

(54) NANOCOMPOSITES COMPRISING HIGH LOADINGS OF MAGNETITE NANOPARTICLES

(71) Applicant: Safe Tek, LLC, Monett, MO (US)

(72) Inventor: Michael Graves, Monett, MO (US)

(21) Appl. No.: 18/350,632

(22) Filed: Jul. 11, 2023

Related U.S. Application Data
(60) Provisional application No. 63/387,136, filed on Dec. 13, 2022.
(60) Provisional application No. 63/368,830, filed on Jul. 19, 2022.
(60) Provisional application No. 63/388,138, filed on Jul. 11, 2022.

(51) Int. Cl. C08K 3/22; C08J 3/20; H01F 1/22

(52) U.S. Cl. CPC C08K 3/22; C08J 3/203; H01F 1/22; C08K 2003/2265; C08K 2003/2227; C08K 2201/011; C08K 2201/01; C08J 2363/02

(57) ABSTRACT

Described herein are nanocomposites, methods of making nanocomposites, and methods of using nanocomposites. The nanocomposites include magnetite nanoparticles. The nanocomposites are useful in a variety of industrial applications.

### CROSS-REFERENCE TO RELATED APPLICATIONS

This application claims priority to U.S. Provisional Application Ser. No. 63/387,136, filed on Dec. 13, 2022, and also claims priority to U.S. Provisional Application Ser. No. 63/368,830, filed on Jul. 19, 2022, and also claims priority to U.S. Provisional Application Ser. No. 63/388,138, filed on Jul. 11, 2022, the contents of which are hereby incorporated by reference in their entirety.

### FIELD OF DISCLOSURE

This disclosure is directed to nanocomposites, methods of making nanocomposites, and methods of using nanocomposites. The nanocomposites include high loadings of magnetite nanoparticles. The nanocomposites are useful in a variety of industrial applications.

### BACKGROUND

Nanocomposite materials present a unique class of materials with numerous potential applications. Nanocomposite materials incorporate nanosized particles into a solid matrix. They often exhibit beneficial properties based on the constituent materials, and the properties may exceed those of the individual constituents. As such, nanocomposite materials can address the constant need for new materials to improve a variety of products.

Nanocomposite materials can include a wide variety of nanosized particles, such as magnetic nanoparticles. Magnetite nanoparticles are a prime example of magnetic nanoparticles. They are magnetic and have been included in various nanocomposites. High loadings of magnetite nanoparticles are desirable to impart beneficial properties. However, nanocomposites often become extremely brittle when the loading of magnetite nanoparticles is too high.

Accordingly, the present application seeks to provide nanocomposites having high loadings of magnetite nanoparticles. It was surprisingly discovered in the present application that nanocomposites could be produced with high loadings of magnetite nanoparticles in the presence of a catalyst, such as further nanoparticles or heat, during production.

Described herein are nanocomposites, methods of making nanocomposites, and methods of using nanocomposites. The nanocomposites include high loadings of magnetite nanoparticles.

### BRIEF DESCRIPTION OF THE DISCLOSURE

In one aspect, provided herein is a nanocomposite comprising: a resin; magnetite nanoparticles; optionally further nanoparticles; and optionally a filler, wherein the magnetite nanoparticles are present in the nanocomposite in an amount of at least 10% by volume.

In another aspect, provided herein is a method of producing a nanocomposite, the method comprising: (i) forming a mixture comprising: a resin polymer or a resin monomer; magnetite nanoparticles; optionally further nanoparticles; and optionally a filler, wherein the magnetite nanoparticles are present in the nanocomposite in an amount of at least 10% by volume; (ii) mixing the mixture; (iii) optionally heating the mixture; (iv) providing the mixture to a mold or surface; and (v) curing the mixture.

In yet another aspect, provided herein is a method of using a nanocomposite comprising: a resin; magnetite nanoparticles; optionally further nanoparticles; and optionally a filler, wherein the magnetite nanoparticles are present in the nanocomposite in an amount of at least 10% by volume, the method comprising using the nanocomposite to form a product selected from the group consisting of composite materials, ballistic materials, ballistic doors, equipment housings, sonar equipment housings, concretes, cements, pipes, optical systems, lasers, lights, spotlights, solar panels, flooring panels, clips, docks, dock bumpers, submersible bumpers, architectural features, facades, coverings, screens, motors, turrets, electrical switches, reed switches, position digitizers, position encoders, and combinations thereof.

### BRIEF DESCRIPTION OF THE DRAWINGS

FIG. 1 is a photograph depicting an exemplary embodiment of nanocomposites in accordance with the present disclosure.

FIG. 2 is a photograph depicting an exemplary embodiment of nanocomposites in accordance with the present disclosure.

FIG. 3 is a photograph depicting an exemplary embodiment of nanocomposites in accordance with the present disclosure.

FIG. 4 is a photograph depicting an exemplary embodiment of an uncured and bubbling nanocomposite in accordance with the present disclosure.

FIG. 5 is a photograph depicting an exemplary embodiment of a front view of a spotlight that is coated on the backside with a nanocomposite in accordance with the present disclosure and is turned off.

FIG. 6 is a photograph depicting an exemplary embodiment of a back view of a spotlight that is coated on the backside with a nanocomposite in accordance with the present disclosure and is turned off.

FIG. 7 is a photograph depicting an exemplary embodiment of a front view of a submersible flooring panel that is coated on the backside with a nanocomposite in accordance with the present disclosure and is turned on.

FIG. 8 is a photograph depicting an exemplary embodiment of a back view of a submersible flooring panel that is coated on the backside with a nanocomposite in accordance with the present disclosure and is turned on.

FIG. 9 is a photograph depicting an exemplary embodiment of a magnetic deadening clip comprising a nanocomposite in accordance with the present disclosure.

FIG. 10 is a photograph depicting an exemplary embodiment of a cast skull comprising a nanocomposite in accordance with the present disclosure and embedded lenses and light emitting diodes, with the light emitting diodes turned off.

FIG. 11 is a photograph depicting an exemplary embodiment of a cast skull comprising a nanocomposite in accordance with the present disclosure and embedded lenses and light emitting diodes, with the light emitting diodes turned on.

FIG. 12 is a photograph depicting an exemplary embodiment of a submersible laser coated with a nanocomposite in accordance with the present disclosure.

FIG. 13 is a photograph depicting an exemplary embodiment of a submersible laser coated with a nanocomposite in accordance with the present disclosure.

FIG. 14 is a photograph depicting an exemplary embodiment of a mold for producing nanocomposites in accordance with the present disclosure.

FIG. 15 is a photograph depicting an exemplary embodiment of a magnetic deadening clip comprising a nanocomposite in accordance with the present disclosure.

FIG. 16 is a photograph depicting an exemplary embodiment of a magnetic deadening clip comprising a luminescent nanocomposite in accordance with the present disclosure.

FIG. 17 is a photograph depicting an exemplary embodiment of sonar images that demonstrate the magnetic field suppression achieved with a magnetic deadening clip comprising a nanocomposite in accordance with the present disclosure.

FIG. 18 is a photograph depicting an exemplary embodiment of a labeled sonar image that demonstrates the magnetic field suppression achieved with a magnetic deadening clip comprising a nanocomposite in accordance with the present disclosure.

FIG. 19 is a photograph depicting an exemplary embodiment of a discharge from a secondary coil of a Tesla coil when a current is applied.

FIG. 20 is a photograph depicting an exemplary embodiment of a lack of a discharge from a secondary coil of a Tesla coil that is surrounded by an open-ended magnetic deadening clip comprising a nanocomposite in accordance with the present disclosure when a current is applied.

FIG. 21 is a photograph depicting an exemplary embodiment of a lack of a discharge from a secondary coil of a Tesla coil that is surrounded by a closed magnetic deadening clip comprising a nanocomposite in accordance with the present disclosure when a current is applied.

FIG. 22 is a photograph depicting an exemplary embodiment of a flexible silicon nanocomposite in accordance with the present disclosure.

FIG. 23 is a photograph depicting an exemplary embodiment of a flexible silicon nanocomposite in accordance with the present disclosure.

FIG. 24 is a photograph depicting an exemplary embodiment of a wireless foot pedal controller including a silicon nanocomposite in accordance with the present disclosure.

FIG. 25 is a photograph depicting an exemplary embodiment of a wireless turret unit with a motor encased in the nanocomposite in accordance with the present disclosure.

FIG. 26 is a photograph depicting an exemplary embodiment of a rotary position digitizer and/or encoder including a reed switch embedded in the nanocomposite in accordance with the present disclosure.

FIG. 27 is a photograph depicting an exemplary embodiment of a submersible solar impact absorbing LED bumper encased in the nanocomposite in accordance with the present disclosure.

FIG. 28 is a diagram depicting an exemplary embodiment of a coated composition in accordance with the present disclosure.

FIG. 29 is a diagram depicting an exemplary embodiment of a coated composition in accordance with the present disclosure.

FIG. 30 is a diagram depicting an exemplary embodiment of a molded composition in accordance with the present disclosure.

FIG. 31 is a method flow chart depicting an exemplary embodiment of a method in accordance with the present disclosure.

### DETAILED DESCRIPTION OF THE DISCLOSURE

The present disclosure is directed to nanocomposites, methods of making nanocomposites, and methods of using nanocomposites. The nanocomposites comprise high loadings of magnetite nanoparticles.

In many embodiments, the nanocomposites comprise a resin, magnetite nanoparticles, optionally further nanoparticles, and optionally a filler.

Generally, the magnetite nanoparticles may be present in any suitable amount known in the art. In many embodiments, the magnetite nanoparticles are present in an amount of at least 10% by volume. Above 10% by volume, the uncured nanocomposite mixture undergoes the tension producing reaction. In many embodiments, the magnetite nanoparticles are present in an amount of at most 90% by volume. Above 90% by volume, the resulting cured nanocomposite becomes more prone to fracture, although it retains almost all of the properties of the original magnetite. Higher mixable concentrations of magnetite nanoparticle, greater than 90% magnetite by mix volume, are achievable using moving magnetic fields as a mixing mechanism.

In many embodiments, the resin and the magnetite nanoparticles are present in the nanocomposite in a ratio in a range of from about 10:1 to about 1:10 by volume. In some embodiments, the resin and the magnetite nanoparticles are present in the nanocomposite in a ratio in a range of from about 5:1 to about 1:5 by volume. In some embodiments, the resin and the magnetite nanoparticles are present in the nanocomposite in a ratio in a range of from about 3:1 to about 1:3 by volume. In some embodiments, the resin and the magnetite nanoparticles are present in the nanocomposite in a ratio in a range of from about 2:1 to about 1:2 by volume.

Generally, the magnetite nanoparticles may be distributed throughout the resin according to any suitable pattern known in the art. In some embodiments, the magnetite nanoparticles are uniformly distributed throughout the resin. In some embodiments, the magnetite nanoparticles are non-uniformly distributed throughout the resin. In some embodiments, the magnetite nanoparticles are selectively distributed throughout the resin.

In some embodiments, the magnetite nanoparticles act as a carrier agent and bind to the rapidly curing resin and optional aggregates. In the presence of a strong electrical or magnetic field, each magnetite nanoparticle is naturally pulled into the field alignment. Due to the simultaneously occurring molecular bonding, tension is generated within the nanocomposite. This internal tension can be used in combination with the disclosed magnetite nanoparticle concentration ratios to generate engineered lattices, walls, shafts, spheres, cones, and/or gridded stiffened areas within the nanocomposite.

Generally, the magnetite nanoparticles may have any suitable diameter known in the art. In many embodiments, the size of the field generated tensioned lattice structure is proportional to the size of the magnetite nanoparticle carrier agent. In some embodiments, the magnetite nanoparticles have an average diameter less than about 50 nm. A particle size less than about 50 nm for the magnetite nanoparticles offers properties which can be altered with concentration ratios. In some embodiments, particle sizes are varied to generate more complex internal magnetic tension carrier field structures.

Generally, the resin may be any suitable resin known in the art. In some embodiments, the resin is selected from the group consisting of epoxy resins, polycarbonate resins, silicone, and combinations thereof.

In many embodiments, the high loading of magnetite nanoparticles is achievable with the use of a catalyst during formation of the nanocomposite. In some embodiments, the catalyst is selected from the group consisting of heat, applied heat, reaction heat, further nanoparticles, microfibers, and combinations thereof.

Generally, the further nanoparticles may be any suitable nanoparticles known in the art. In some embodiments, the further nanoparticles are selected from the group consisting of metal oxide nanoparticles, aluminum oxide nanoparticles, chromium(III) phosphate nanoparticles, chromium(VI) phosphate nanoparticles, silica nanoparticles, copper nanoparticles, titanium nanoparticles, zinc nanoparticles, zinc oxide nanoparticles, and combinations thereof. In some embodiments, the further nanoparticles are aluminum oxide nanoparticles.

Generally, the further nanoparticles may be present in any suitable amount known in the art. Very fast glassing reaction are observed at relatively high amounts of further nanoparticles. In many embodiments, the magnetite nanoparticles and the further nanoparticles are present in the nanocomposite in a ratio in a range of from about 10:1 to about 1:10 by volume. In some embodiments, the magnetite nanoparticles and the further nanoparticles are present in the nanocomposite in a ratio in a range of from about 5:1 to about 1:5 by volume. In some embodiments, the magnetite nanoparticles and the further nanoparticles are present in the nanocomposite in a ratio in a range of from about 3:1 to about 1:3 by volume. In some embodiments, the magnetite nanoparticles and the further nanoparticles are present in the nanocomposite in a ratio in a range of from about 2:1 to about 1:2 by volume. In some embodiments, the magnetite nanoparticles and the further nanoparticles are present in the nanocomposite in a ratio in a range of from about 10:1 to about 1:1 by volume.

Generally, the further nanoparticles may have any suitable diameter known in the art. In some embodiments, the further nanoparticles have an average diameter in a range of from about 50 nm to about 150 nm. In some embodiments, the further nanoparticles have an average diameter less than about 50 nm.

Generally, the filler may be any suitable filler known in the art. In some embodiments, the filler is selected from the group consisting of trash fillers, plastic fillers, fiber reinforcement fillers, high density polyethylene, polypropylene, polystyrene, and combinations thereof. In some embodiments, the filler glasses within the nanocomposite when encapsulated. In some embodiments, polystyrene glasses entirely within the nanocomposite when encapsulated. In many embodiments, the nanocomposite substantially encapsulates the filler without resulting weakness in the nanocomposite. In these embodiments, it is particularly beneficial for the filler to be a trash filler to enable disposal of the trash filler in the nanocomposite.

In some embodiments, the resin, the magnetite nanoparticles, and the further nanoparticles are present in the nanocomposite in a ratio of about 1:4:2 by volume. In some embodiments, the resin, the magnetite nanoparticles, and the filler are present in the nanocomposite in a ratio of about 1:2:3 by volume. In these embodiments, compression at 12,000 psi has been observed after 7 days of curing.

In some embodiments, the nanocomposite is luminescent and/or phosphorescent. In these embodiments, the nanocomposite comprises a luminescent component. In some embodiments, the nanocomposite comprises strontium aluminate, aluminum, aluminum shavings, and combinations thereof.

Generally, the nanocomposites may be produced according to any suitable method known in the art. In some embodiments, a nanocomposite is produced according to a method comprising: (i) forming a mixture comprising: a resin polymer or a resin monomer; magnetite nanoparticles; optionally further nanoparticles; and optionally a filler, wherein the magnetite nanoparticles are present in the nanocomposite in an amount of at least 10% by volume; (ii) mixing the mixture; (iii) optionally heating the mixture; (iv) providing the mixture to a mold or surface; and (v) curing the mixture.

In many embodiments, the method step of mixing the mixture comprises mixing the mixture with a mixer. In some embodiments, the method step of mixing the mixture comprises mixing the mixture with a magnet. In some embodiments, the method step of mixing the mixture comprises mixing the mixture with a non-contact magnet.

In some embodiments, the method step of mixing the mixture polymerizes the resin monomer. In these embodiments, the resin is provided to the mixture in the form of a resin monomer. In some embodiments, the resin monomer is a resin prepolymer. In some embodiments, the resin monomer comprises separate monomer components configured to react and form the resin monomer. In some embodiments, the resin monomer comprises epichlorohydrin and bisphenol A.

Generally, the mixture may be heated to any suitable temperature known in the art. In some embodiments, the method step of heating the mixture comprises heating the mixture to a temperature in a range of from about 35° C. to about 65° C. In some embodiments, the method step of heating the mixture comprises heating the mixture with applied heating. In some embodiments, the method step of heating the mixture comprises heating the mixture with by the heat released during reaction.

In some embodiments, with the addition of further nanoparticles such as zinc oxide or copper oxide above 10% with a magnetite nanoparticle amount above 25%, temperatures have been observed to rise above 85° C. and a rapid glassing or crystallization occurs. At these concentrations, no additional heat is required and generally demolding can occur in under 15 minutes, with full curing in approximately 72 hours. In lower catalyst concentrations, heat can be added using heated air devices, torches, or induction heating.

It was surprisingly discovered in the present application that an uncured nanocomposite mixture could distribute itself across conducting surfaces. In some embodiments, the method step of providing the mixture to a mold or surface comprises providing the mixture to a portion of a conducting surface, wherein the mixture distributes itself across the conducting surface.

In some embodiments, the method step of providing the mixture to a mold or surface comprises providing the mixture to a portion of a surface and selectively distributing the mixture across the surface with a magnet.

In some embodiments, the method step of curing the mixture comprises curing the mixture for a time in a range of from about 1 hour to about 96 hours. In some embodiments, the method step of curing the mixture comprises curing the mixture for a time of at least about 1 hours.

In some embodiments, the nanocomposite is casted. In some embodiments, the nanocomposite is produced with a mold. In some embodiments, the nanocomposite is produced with a 3-D printed mold. In some embodiments, the 3-D printed mold is produced with a 3-D model and a 3-D printer. In some embodiments, the nanocomposite is machinable for post-casting modifications.

Generally, the nanocomposites may be used according to any suitable method known in the art. In some embodiments, a nanocomposite is used according to a method comprising using the nanocomposite to form a product selected from the group consisting of composite materials, ballistic materials, ballistic doors, equipment housings, sonar equipment housings, concretes, cements, pipes, optical systems, lasers, lights, spotlights, solar panels, flooring panels, clips, docks, dock bumpers, submersible bumpers, architectural features, facades, coverings, screens, motors, turrets, electrical switches, reed switches, position digitizers, position encoders, and combinations thereof.

In some embodiments, the method step of using the nanocomposite improves a property of the product selected from the group consisting of impact resistance, ballistics resistance, heat absorption, radiation absorption, radiofrequency shielding, magnetic field shielding, luminescence, and combinations thereof.

In some embodiments, the nanocomposite is used to coat the product.

In some embodiments, a product comprises the nanocomposite, wherein the product is selected from the group consisting of ballistic materials, ballistic doors, equipment housings, sonar equipment housings, concretes, cements, pipes, optical systems, lasers, lights, spotlights, solar panels, flooring panels, clips, docks, dock bumpers, submersible bumpers, architectural features, facades, coverings, screens, motors, turrets, electrical switches, reed switches, position digitizers, position encoders, and combinations thereof.

In many embodiments, the nanocomposite may be used in a composite material. In some embodiments, a composite comprises the nanocomposite, wherein the composite comprises a substrate and the nanocomposite bonded to the substrate. In some embodiments, the substrate is selected from the group consisting of transition metals, copper, iron, stainless steel, concrete, porous materials, wood, cardboard, aluminum, pretreated aluminum, density polyethylene (LDPE), and combinations thereof.

In some embodiments, the composite does not comprise a bonding agent. In these embodiments, the nanocomposite acts as its own plasticizer and/or a carrier agent for the composite.

In some embodiments, a composite comprises two or more nanocomposites according to the present disclosure. In these embodiments, the nanocomposites have different compositions. As one non-limiting example, the composite may comprise a first nanocomposite having a composition imparting relatively high rigidity and a second nanocomposite having a composition imparting relatively high flexibility.

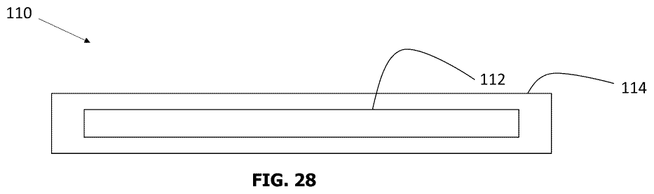

FIG. 28 is an exemplary diagram of a coated composition 110. In this exemplary embodiment, coated composition 110 depicts an exemplary coated composition and is not intended to limit the composition embodiments. In the exemplary embodiment, coated composition 110 includes product 112 entirely coated with a nanocomposite coating 114 in accordance with the present disclosure.

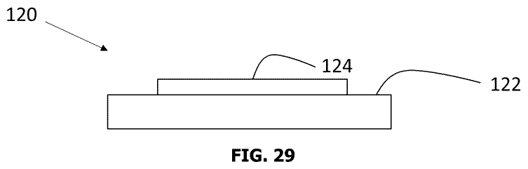

FIG. 29 is an exemplary diagram of a coated composition 120. In this exemplary embodiment, coated composition 120 depicts an exemplary coated composition and is not intended to limit the composition embodiments. In the exemplary embodiment, coated composition 120 includes product 122 partially coated with a nanocomposite coating 124 in accordance with the present disclosure.

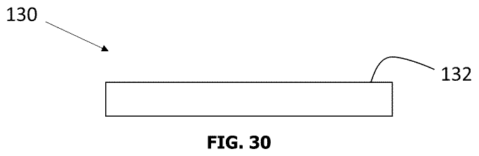

FIG. 30 is an exemplary diagram of a molded composition 120. In this exemplary embodiment, composition 130 depicts a molded composition and is not intended to limit the composition embodiments. In the exemplary embodiment, composition 130 includes a molded nanocomposite 132 in accordance with the present disclosure.

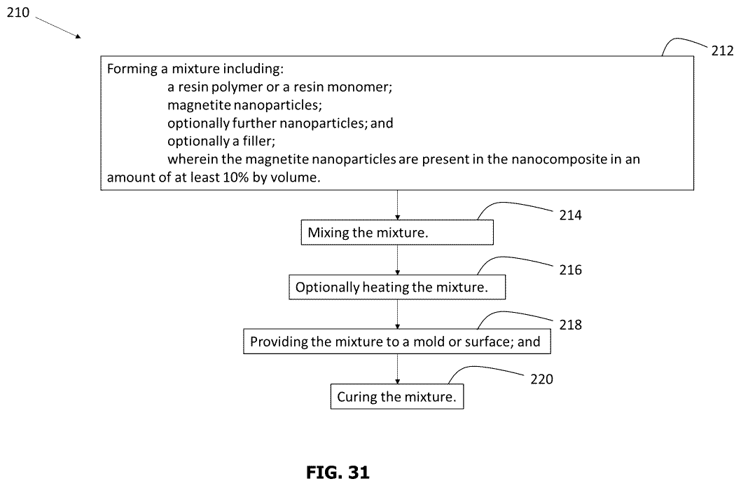

FIG. 31 is an exemplary method flow chart 210. In this exemplary embodiment, method flow chart 210 depicts exemplary steps of the method embodiments of producing a nanocomposite described herein and is not intended to limit the method embodiments. In the exemplary embodiment, the method includes forming 212 a mixture including: a resin polymer or a resin monomer; magnetite nanoparticles; optionally further nanoparticles; and optionally a filler; wherein the magnetite nanoparticles are present in the nanocomposite in an amount of at least 10% by volume; mixing 214 the mixture; optionally heating 216 the mixture; providing 218 the mixture to a mold or surface; and curing 220 the mixture.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever.

### Example 1. Nanocomposite Formation on a Surface

In this exemplary embodiment, it is demonstrated that nanocomposites in accordance with the present disclosure may be used to coat a surface. The nanocomposites may partially or totally coat the surface.

Magnetite nanoparticles (Fe²⁺Fe³⁺₂O₄) and aluminum oxide nanoparticles (Al₂O₃) were combined with epoxy resin components epichlorohydrin and bisphenol A in cement aggregate amounts (e.g., a ratio of about 2 parts magnetite, 1 part aluminum oxide, and 1 part epoxy resin components by volume) to form a mixture. The mixture was mixed using non-contact magnets and then a portion of the mixture (e.g., a quarter sized dollop) was placed in the center of a conducting plate (e.g., a copper plate). While on the conducting plate, the mixture was drawn across the conducting plate on its own and without the use of added current or magnets. Similar auto-distribution was not observed when a portion was placed on a non-conducting plate. Although not limited by any particular theory, it is believed that the mixture generated a current on the conducting plate, which subsequently pulled the mixture to the edges of the plate. Once the mixture covered the conducting plate, it was allowed to cure. The curing reaction was slightly exothermic and the curing mixture reached temperatures up to about 57° C. The mixture was in a semi-hard but moldable state after just 1-2 hours. In this state, the exterior edges of the mixture were relatively hard while the interior portions were relatively soft. The mixture fully cured after about 96 hours.

### Example 2. Nanocomposite Formation in a Mold

In this exemplary embodiment, it is demonstrated that nanocomposites in accordance with the present disclosure may be used to form a standalone molded component. The nanocomposites may take on the form and shape of the mold.

Magnetite nanoparticles (Fe²⁺Fe³⁺₂O₄) and aluminum oxide nanoparticles (Al₂O₃) were combined with epoxy resin components epichlorohydrin and bisphenol A in cement aggregate amounts (e.g., a ratio of about 2 parts magnetite, 1 part aluminum oxide, and 1 part epoxy resin components by volume) to form a mixture. The mixture was mixed using non-contact magnets and then a portion of the mixture was poured into a mold and allowed to cure. The curing reaction was slightly exothermic and the curing mixture reached temperatures up to about 57° C. The mixture was in a semi-hard but moldable state after just 1-2 hours. In this state, the exterior edges of the mixture were relatively hard while the interior portions were relatively soft. The mixture fully cured after about 96 hours. Curing thicknesses of several inches were achievable and a maximum curing depth was not observed up to 4 inches.

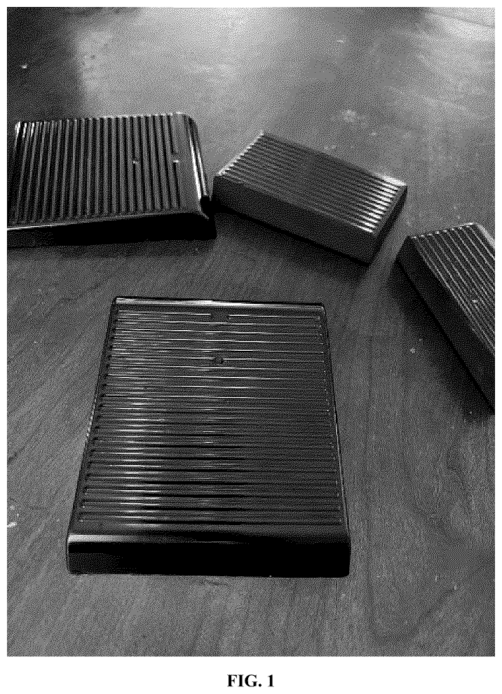

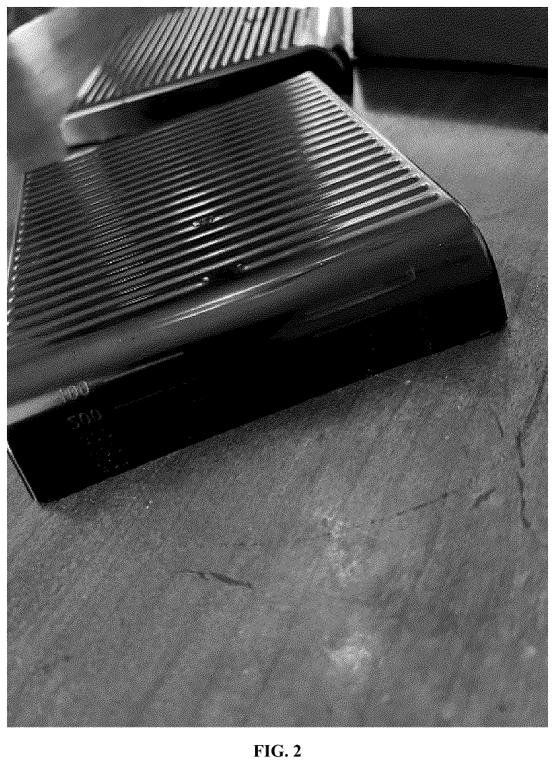

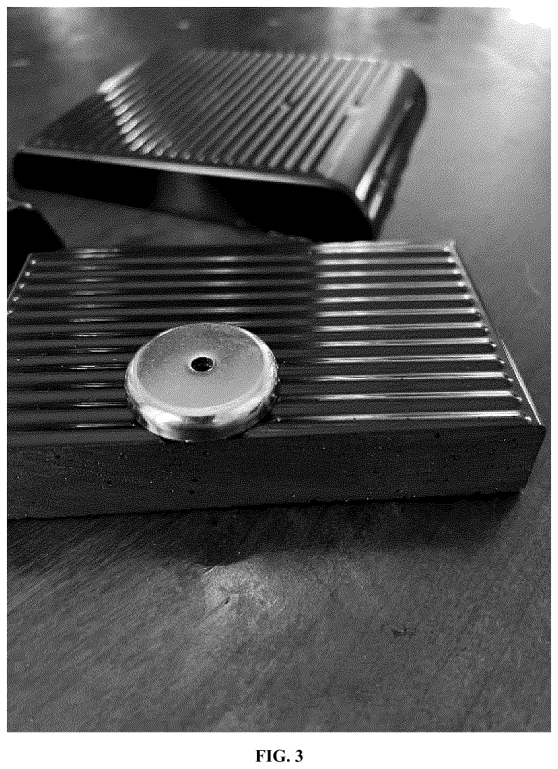

Photographs of the resulting nanocomposites, taken after about two hours after completed curing, are shown in FIGS. 1-3. As can be seen, the nanocomposites are uniform. The silver ring in FIG. 3 is a magnet that is held to the cured nanocomposite by magnetic force.

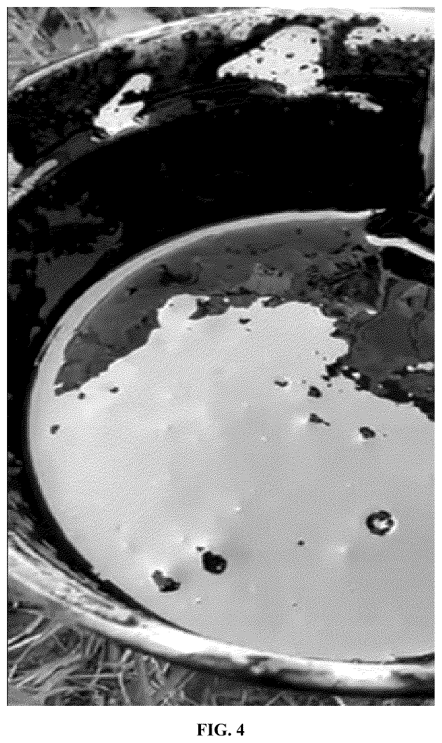

A photograph of the nanocomposite, taken before curing, is shown in FIG. 4. As can be seen, the nanocomposite mixture is uniform. There are bubbles in the mixture, which are believed to be present due to boiling and/or release of gas in exothermic reactions.

### Example 3. Nanocomposite Testing

In this exemplary embodiment, it is demonstrated that nanocomposites in accordance with the present disclosure may possess an array of different properties. These properties may individually and collectively be present in any compositions according to the present disclosure.

The various material properties of the nanocomposites producing according to Examples 1 and 2 were tested. The properties and corresponding observations are shown in the table below.

TABLE 1
Properties of the nanocomposites and related observations.

| Property | Observation |
|---|---|
| Heat absorption | The nanocomposites were found to be |
| | warm, but not hot, after being placed in |
| | direct sunlight for several hours. |
| Electricity conductance | The nanocomposites do not conduct |
| | electricity. |
| Magnetism | The nanocomposites are magnetic. |
| Impact resistance | A nanocomposite having one-half inch |
| | thickness was able to stop a 9 mm bullet |
| | fired at 10 meters. |
| Radiation absorbance | The nanocomposites absorbed sound waves |
| | such as sonic frequencies. The |
| | nanocomposites also absorbed interference |
| | from electrical data transmission. The |
| | nanocomposites also absorbed light waves |
| | and appeared a deep black color. |
| Fracturing | The nanocomposites were fractured using |
| | 30 tons of force from a hydraulic ram. Less |
| | force did not produce significant fracturing. |
| | The fractured piece was analyzed, and a |
| | crystal structure was visually observed in |
| | the fractured piece. |
| Tunable density | During formation, the uncured |
| | nanocomposite mixture could be moved on |
| | a copper plate through the application of a |
| | magnetic field. In this way, |
| | nanocomposites having tunable and non- |
| | uniform densities could be formed. |

### Example 4. Composite Formation

In this exemplary embodiment, it is demonstrated that nanocomposites in accordance with the present disclosure may be used to form a composite by bonding the nanocomposites to a substrate. The substrate may be any suitable substrate.

Composites were formed by bonding the nanocomposites produced according to Example 1 to a substrate. The nanocomposites act as their own plasticizers and bond to any conductive material. Substrates that exhibited excellent bonding include iron, copper, stainless steel, concrete, porous materials (e.g., wood or cardboard), aluminum, chrome phosphate pre-treated aluminum, and low-density polyethylene (LDPE). Substrates that exhibited poor bonding include polyvinyl chloride (PVC) pipe, high-density polyethylene (HDPE), and silicone. With poor or no bonding, all of the tension stays in the surface of the material, thereby generating a surface porosity so low that two cast 2-inch diameter cylinders will stick together from surface tension alone on the flat cast faces.

### Example 5. Spotlight

In this exemplary embodiment, it is demonstrated that nanocomposites in accordance with the present disclosure may be used to coat a product and impart the benefits of their properties. The product may be any suitable product, such as a product that would benefit from being shielded from electromagnetic fields.

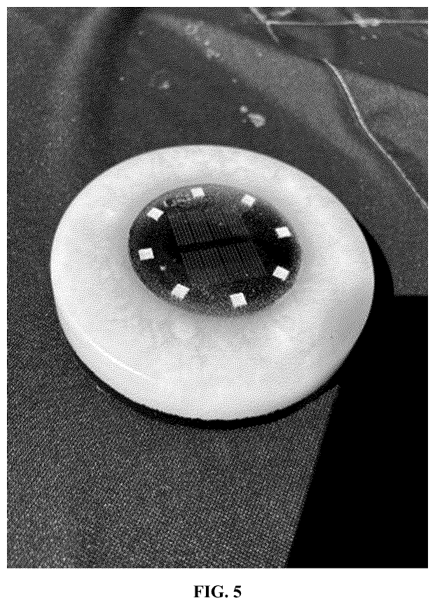

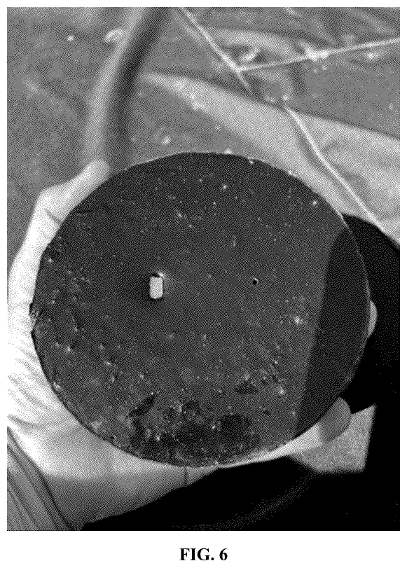

To demonstrate one use of the nanocomposite in accordance with the present disclosure, a spotlight was coated with the nanocomposite on the backside of the spotlight. The nanocomposite includes 25% shredded single use trash plastic as a binding aggregate. The spotlight is shown in FIGS. 5-6 and is turned off. The spotlight includes LEDs arranged around a solar cell. The power system of the spotlight is entirely self-contained and monolithic, so it is anticipated to be long-lasting. With the nanocomposite, it is also magnetic and may be secured by a magnetic force. In addition, the nanocomposite provides shielding from electromagnetic fields.

### Example 6. Flooring Panel

In this exemplary embodiment, it is demonstrated that nanocomposites in accordance with the present disclosure may be used to coat a product and impart the benefits of their properties. The product may be any suitable product, such as a product that would benefit from being shielded from electromagnetic fields.

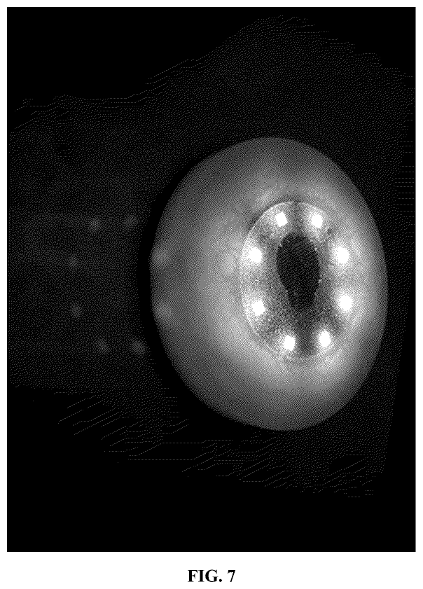

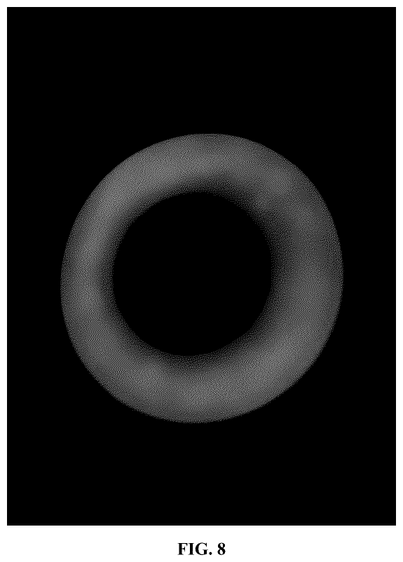

To demonstrate one use of the nanocomposite in accordance with the present disclosure, a submersible flooring panel having built-in LEDs was coated with the nanocomposite on the backside of the submersible flooring panel. The nanocomposite includes 25% shredded single use trash plastic as a binding aggregate. The submersible flooring panel is shown in FIGS. 7-8 and is turned on.

The submersible flooring panel is solar-powered, magnetic, and surface-cooling, and has built-in LEDs exhibiting 12-hour photoluminescence when charged. The submersible flooring panel may be a tile or plank. The power system of the submersible flooring panel is entirely self-contained and monolithic, so it is anticipated to be long-lasting.

### Example 6. Magnetic Deadening Clip

In this exemplary embodiment, it is demonstrated that nanocomposites in accordance with the present disclosure may be used to coat and/or mold a product and impart the benefits of their properties. The product may be any suitable product, such as a product that would impart shielding from electromagnetic fields to other products.

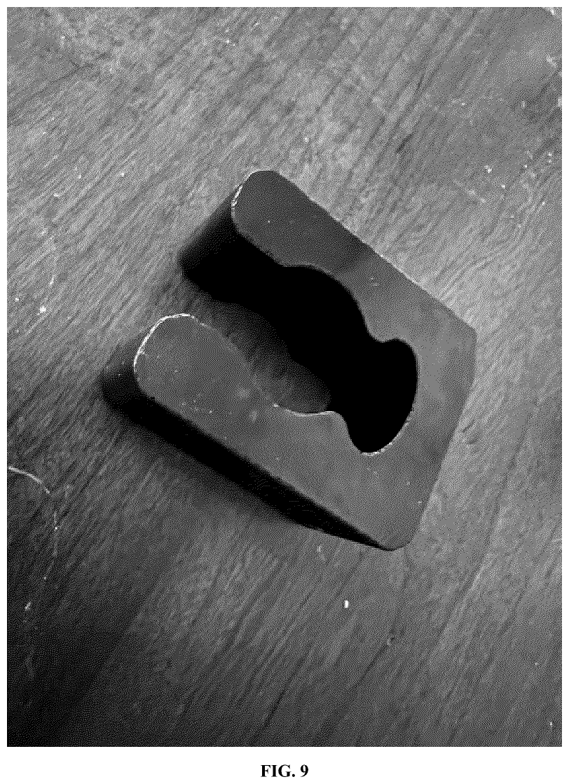

To demonstrate one use of the nanocomposite in accordance with the present disclosure, a magnetic deadening clip was formed from the nanocomposite. In particular, the magnetic deadening clip includes a core having a nanocomposite including 60% magnetite concentration and an outer surface having a nanocomposite including 25% magnetite concentration so that the outer surface is more flexible. The magnetic deadening clip is shown in FIG. 9. A magnetic deadening clip of this composition is particularly useful in fishing applications, such as to replace iron core cable clips that attach sonar cables to a stainless-steel pole of a trolling motor or other sonar transducer positioning system.

### Example 7. Embedded Optical Components

In this exemplary embodiment, it is demonstrated that nanocomposites in accordance with the present disclosure may be used to coat articles having complex shapes. It is also demonstrated that nanocomposites in accordance with the present disclosure may be used to improve optical properties, such as by focusing lenses.

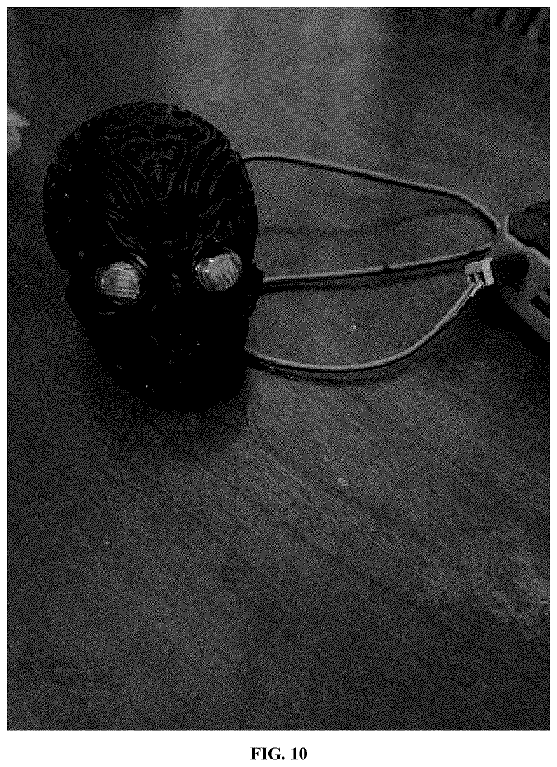

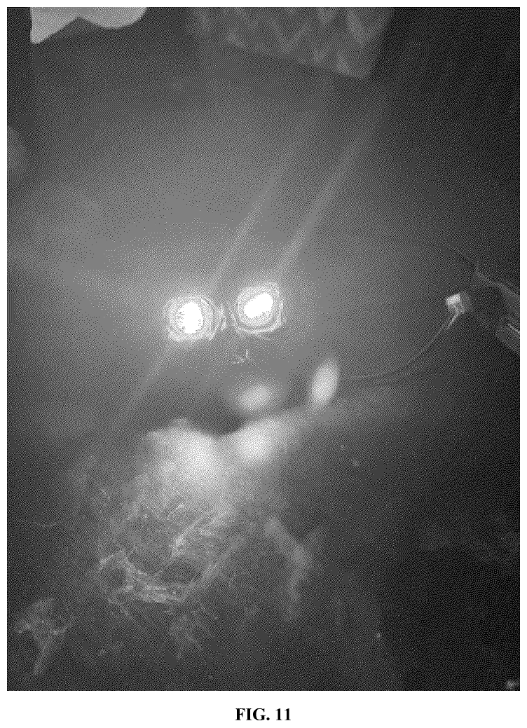

To demonstrate one use of the nanocomposite in accordance with the present disclosure, lenses and light emitting diodes (LEDs) were embedded in a cast figure having the shape of a skull and comprising the nanocomposite. The cast skull is shown in FIGS. 10-11. The asymmetric shape of the skull and detailed grooves indicate that a wide variety of shapes and designs may be casted using the nanocomposite. Embedding the lenses and LEDs in the nanocomposite amplifies the focus of the lenses, thereby making the LEDs appear brighter when turned on.

### Example 8. Submersible Laser

In this exemplary embodiment, it is demonstrated that nanocomposites in accordance with the present disclosure may be used to coat a product and impart the benefits of their properties. The product may be any suitable product, such as a product that would benefit from being shielded from electromagnetic fields.

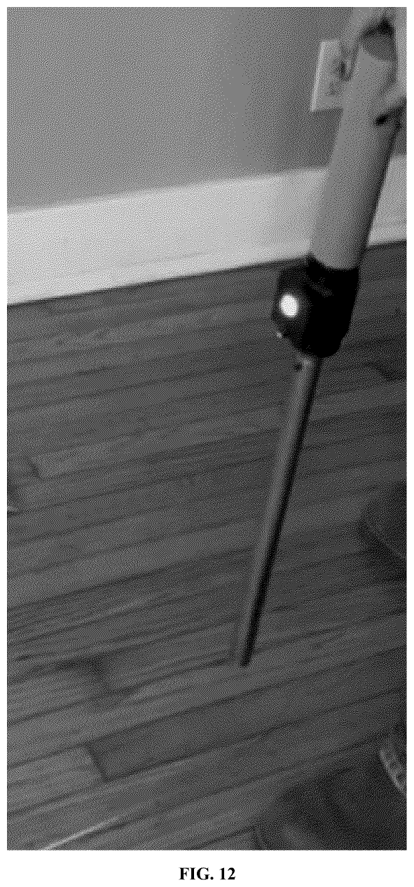

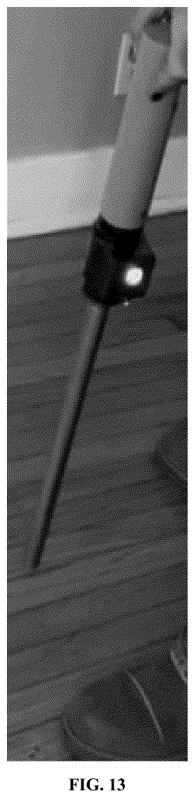

To demonstrate one use of the nanocomposite in accordance with the present disclosure, a submersible laser was coated with a nanocomposite. The submersible laser is shown in FIGS. 12-13. The submersible laser is shielded from EMF radiation and thereby exhibits enhanced sensitivity.

### Example 9. 3-D Printed Mold

In this exemplary embodiment, it is demonstrated that nanocomposites in accordance with the present disclosure may be used to form a standalone molded component via a 3-D printed mold. The nanocomposites may take on the form and shape of a mold produced by a 3-D printer.

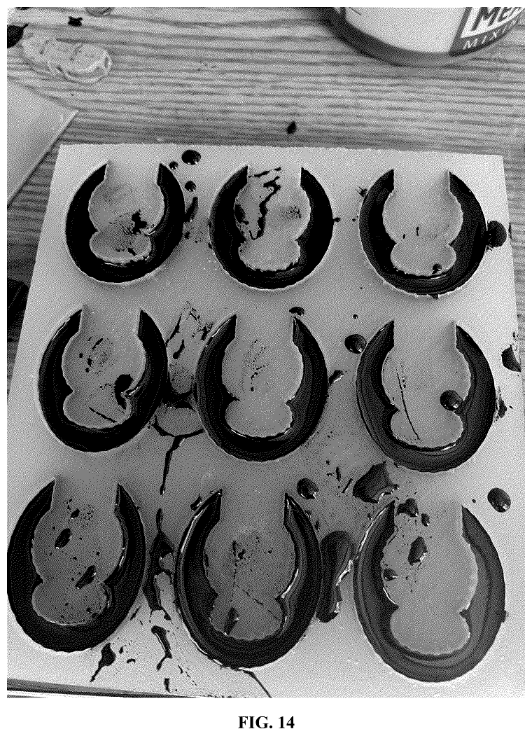

To demonstrate a method of making the nanocomposite in accordance with the present disclosure, a mold was created. The mold is shown in FIG. 14, where the nanocomposite mixture is poured into the mold. It is subsequently cured. The mold was 3-D printed and allows for simultaneous production of nine magnetic deadening clips. In particular, a mold negative having a bevel on both faces of the component was created with a 3-D model and a 3-D printer. The mold negative was case in silicone rubber and then extracted, including asymmetrical components, from the rubber silicone mold. This process is highly scalable at a relatively low cost. The 3-D printed mold negative can be used to produce further silicone molds. This 3-D printing method requires no release agents or excessive mold cleanup after extraction.

### Example 10. Luminescent Nanocomposites

In this exemplary embodiment, it is demonstrated that nanocomposites in accordance with the present disclosure may be used to mold a product. The product may be any suitable product, such as a product that would impart shielding from electromagnetic fields to other products. If luminescent particles are added to the nanocompo sites, the product will change colors upon luminescence.

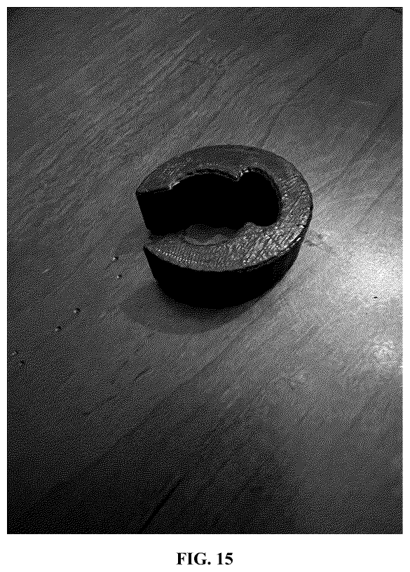

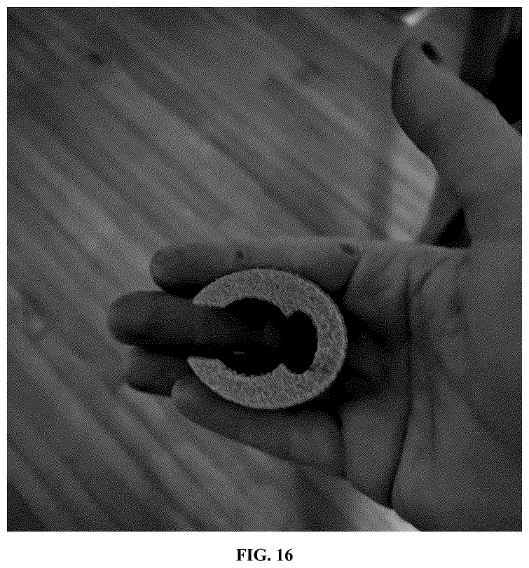

To demonstrate one use of the nanocomposite in accordance with the present disclosure, a luminescent nanocomposite was formed. A magnetic deadening clip comprising the luminescent nanocomposite is shown in FIGS. 15-16. This clip is colored black in ordinary light, such as sunlight, but it can change colors upon luminescence (e.g., phosphorescence) in the dark. The color change can be, for example, red, green, blue, or white. This luminescent behavior is achieved by adding aluminum shavings and strontium aluminate to a nanocomposite mixture. In particular, aluminum shavings and strontium aluminate may be combined in a mixture and then this separate mixture may be blended with the nanocomposite mixture in a mold once the nanocomposite mixture becomes elastic in the curing elastic. Although it is believed that the strontium aluminate is responsible for the luminescent properties, the aluminum shavings pocketed inside the blend nanocomposite mixture (e.g., a 30% blend) results in a similar photo resonance effect. In this way, a moldable, submersible, ballistic, high thermal, monolithic photon storage/diffuser/focusing backer can be created.

### Example 11. Magnetic Field Suppression

In this exemplary embodiment, it is demonstrated that nanocomposites in accordance with the present disclosure may be used to mold a product and impart the benefits of their properties. The product may be any suitable product, such as a product that would impart shielding from electromagnetic fields to other products. The product may be used, for example, to reduce noise from electromagnetic fields and enhance sensitivity of electrical equipment.

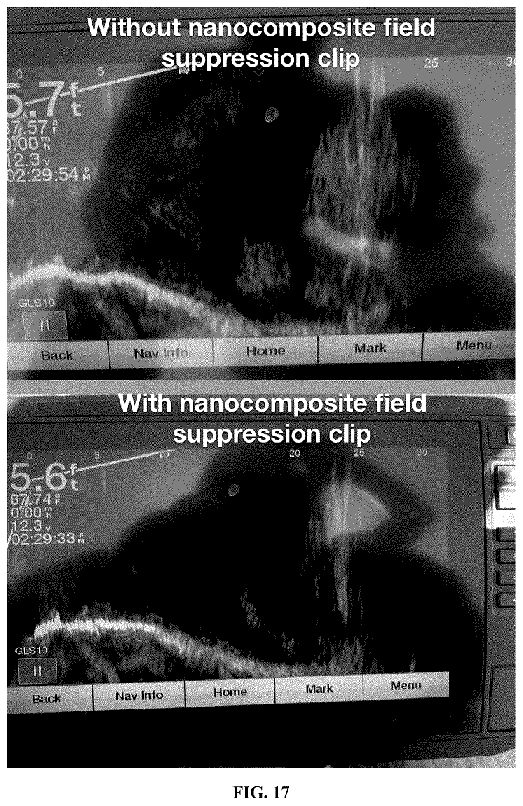

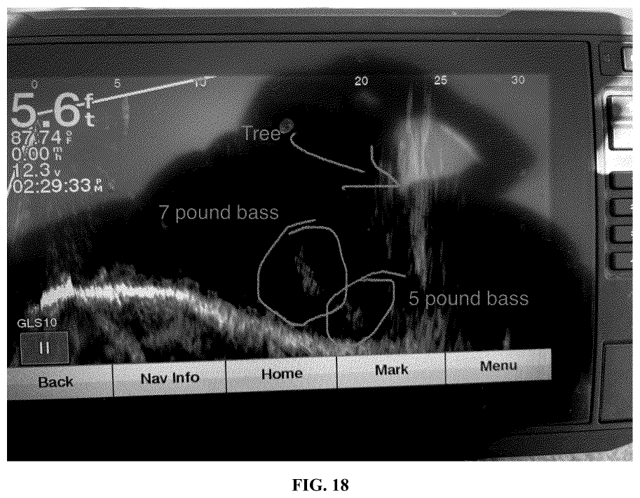

To demonstrate one use of the nanocomposite in accordance with the present disclosure, a magnetic deadening clip comprising a nanocomposite in accordance with the present disclosure was formed. Sonar images depicting the use of the magnetic deadening clip to suppress and scrub magnetic fields are shown in FIGS. 17-18. Noise reduction of about 20-25% was observed with the magnetic deadening clip. As shown in FIG. 18, the separate events of a 7-pound bass, a 5-pound bass, and a tree are readily visible. In contrast, these separate events are not distinguishable in the top image of FIG. 17, which does not include a magnetic deadening clip.

### Example 12. Magnetic Field Suppression

In this exemplary embodiment, it is demonstrated that nanocomposites in accordance with the present disclosure may be used to mold a product and impart the benefits of their properties. The product may be any suitable product, such as a product that would impart shielding from electromagnetic fields to other products. The product may be used, for example, to prevent discharge in an electrical coil.

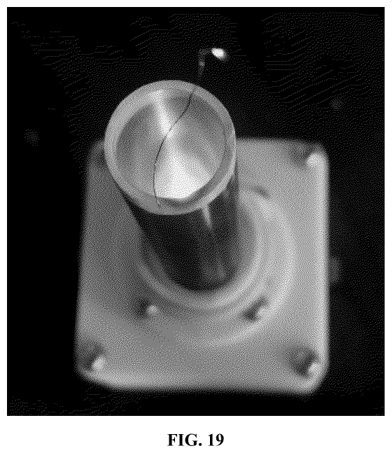

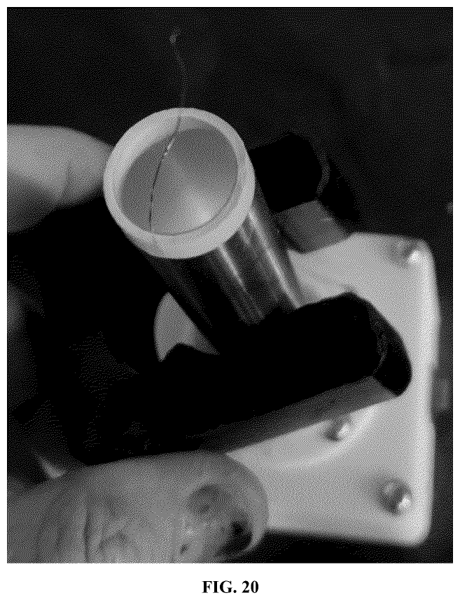

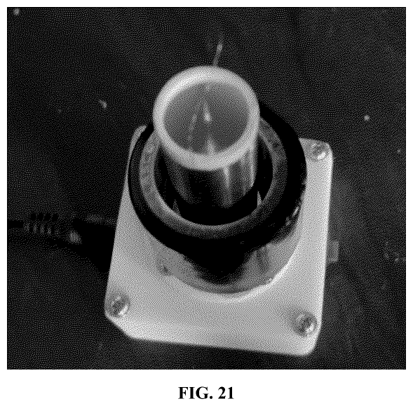

To demonstrate one use of the nanocomposite in accordance with the present disclosure, a magnetic deadening clip comprising a nanocomposite in accordance with the present disclosure was formed. As shown in FIG. 19, there is ordinarily a discharge from a secondary coil when a current is applied. But as shown in FIG. 20, an open-ended magnetic deadening clip comprising a nanocomposite in accordance with the present disclosure cancels out the discharge from the secondary coil. Similarly, as shown in FIG. 21, a closed magnetic deadening clip comprising a nanocomposite in accordance with the present disclosure cancels out the discharge from the secondary coil.

### Example 13. Flexible Nanocomposites

In this exemplary embodiment, it is demonstrated that nanocomposites in accordance with the present disclosure may be used to form flexible products by combining the nanocomposites with a flexible material such as silicone.

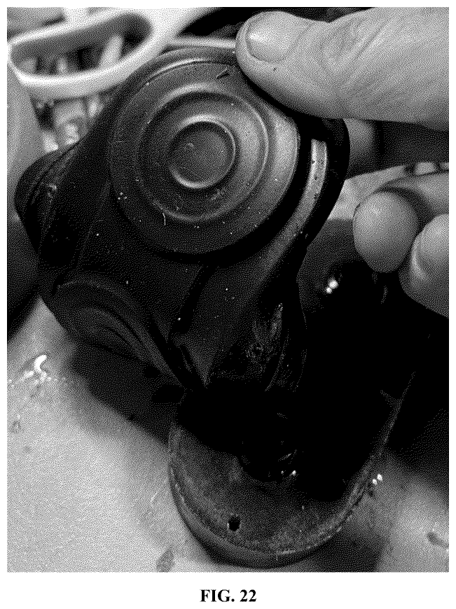

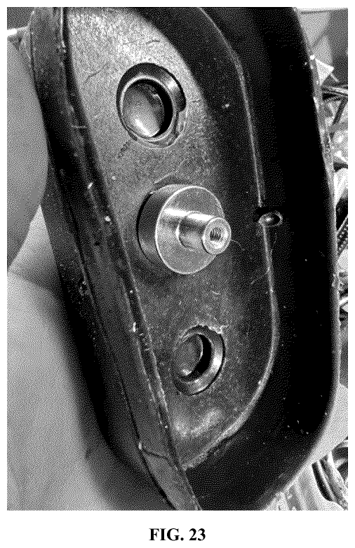

To demonstrate one use of the nanocomposite in accordance with the present disclosure, a flexible silicone nanocomposite in accordance with the present disclosure was formed. The flexible silicone nanocomposite may be formed with two-part silicone in the same ratios as the two-part resin described herein. Images depicting the silicone nanocomposite are shown in FIGS. 22 and 23. The silicone composite is shown to be flexible in FIG. 22. The silicone nanocomposite is shown to be modifiable in FIG. 23, where a hole has been drilled through the middle and a fastener has been secured.

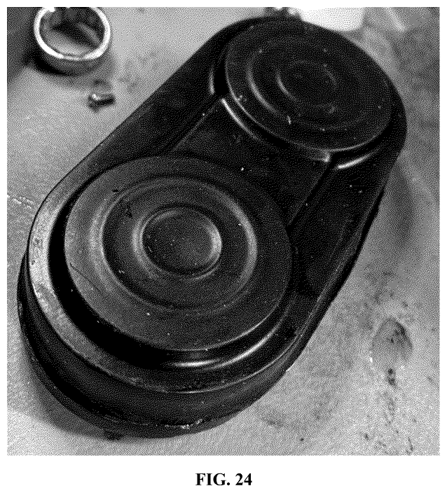

The silicone nanocomposite is broadly applicable. For example, it may be used in a wireless foot pedal controller, as shown in FIG. 24. As another example, it may be used to encase a motor, such as an electric motor, as exemplified in Example 14. Encasing the motor provides properties of waterproofing, sound dampening, and magnetic interference elimination when near a sonar transducer.

### Example 14. Wireless Turret

In this exemplary embodiment, it is demonstrated that nanocomposites in accordance with the present disclosure may be used to coat a product and impart the benefits of their properties. The product may be any suitable product, such as a product that would benefit from shielding from electromagnetic fields.

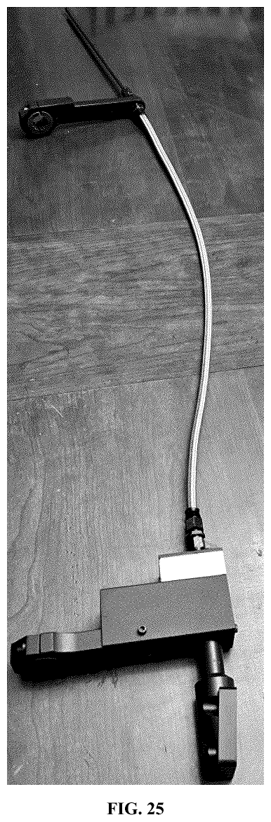

To demonstrate one use of the nanocomposite in accordance with the present disclosure, a wireless turret unit with a motor encased in the nanocomposite in accordance with the present disclosure was produced. The turret is shown in FIG. 25. The motor is an electric motor, and it is encased in the silicone nanocomposite of Example 13 within an aluminum housing. As a result, the motor is a submersible, magnetically deadened motor. The silicone nanocomposite serves as a noise, electromagnetic field, and water barrier.

### Example 15. Devices Including a Reed Switch

In this exemplary embodiment, it is demonstrated that nanocomposites in accordance with the present disclosure may be used to coat a product and impart the benefits of their properties. The product may be any suitable product, such as a product that would benefit from shielding from electromagnetic fields. The product may be used, for example, in electrical switching components.

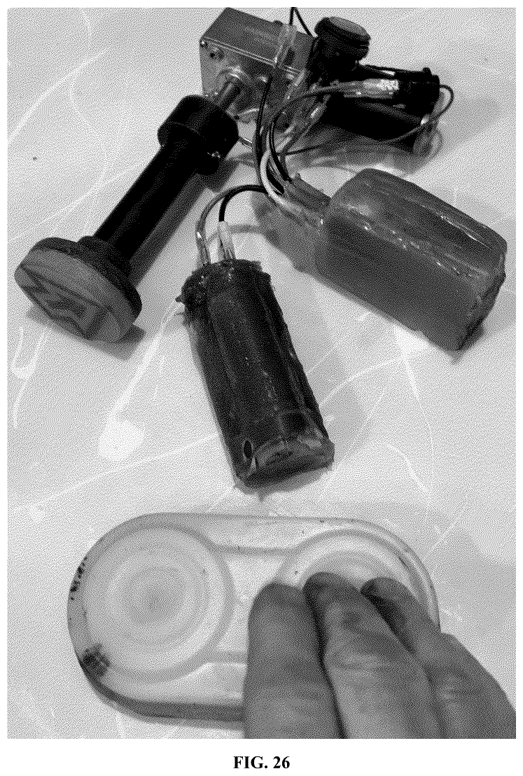

To demonstrate one use of the nanocomposite in accordance with the present disclosure, a reed switch comprising a nanocomposite in accordance with the present disclosure was formed. A device including the reed switch is shown in FIG. 26. In particular, the device is a rotary position digitizer and/or encoder including the reed switch embedded in the nanocomposite. Remote actuation of the reed switch controls rotary position.

Generally, normally closed reed switches can be used to produce limits, while normally open reed switches can be used to create position encoding and/or indication. Rotary limit switches allowing for direction reversal can be produced based on two reed switches, each comprising the nanocomposite, connected in series, along with a current direction limiting diode. A series of normally open reed switches can be used to produce a circuit to a control board for adjustable position indication.

### Example 16. Submersible Solar Impact Absorbing LED Bumper

In this exemplary embodiment, it is demonstrated that nanocomposites in accordance with the present disclosure may be used to coat a product and impart the benefits of their properties. The product may be any suitable product, such as a product that would benefit from impact absorption. The product may be used, for example, in a vehicle bumper.

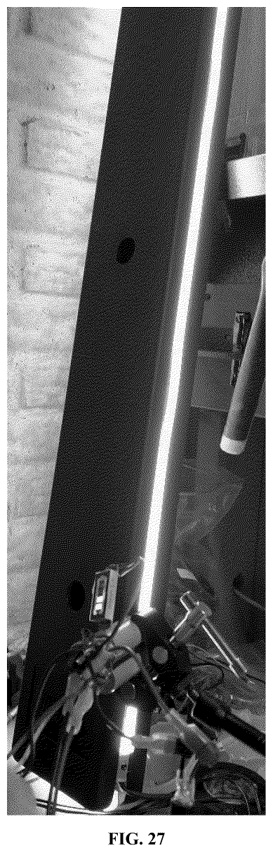

To demonstrate one use of the nanocomposite in accordance with the present disclosure, a submersible solar impact absorbing LED bumper encased in the nanocomposite in accordance with the present disclosure was produced. The submersible bumper is shown in FIG. 27.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A nanocomposite comprising:
a resin;
magnetite nanoparticles;
optionally further nanoparticles; and
optionally a filler;
wherein the magnetite nanoparticles are present in the nanocomposite in an amount of at least 10% by volume.

2. The nanocomposite of claim 1, wherein the magnetite nanoparticles are uniformly distributed throughout the resin.

3. The nanocomposite of claim 1, wherein the magnetite nanoparticles are non-uniformly distributed throughout the resin.

4. The nanocomposite of claim 1, wherein the resin is selected from the group consisting of epoxy resins, polycarbonate resins, silicone, and combinations thereof.

5. The nanocomposite of claim 1, wherein the magnetite nanoparticles have an average diameter less than about 50 nm.

6. The nanocomposite of claim 1, wherein the further nanoparticles are selected from the group consisting of metal oxide nanoparticles, aluminum oxide nanoparticles, chromium(III) phosphate nanoparticles, chromium(VI) phosphate nanoparticles, silica nanoparticles, copper nanoparticles, titanium nanoparticles, zinc nanoparticles, zinc oxide nanoparticles, and combinations thereof.

7. The nanocomposite of claim 1, wherein the filler is selected from the group consisting of trash fillers, plastic fillers, fiber reinforcement fillers, high density polyethylene, polypropylene, polystyrene, and combinations thereof.

8. A product comprising the nanocomposite of claim 1, wherein the product is selected from the group consisting of ballistic materials, ballistic doors, equipment housings, sonar equipment housings, concretes, cements, pipes, optical systems, lasers, lights, spotlights, solar panels, flooring panels, clips, docks, dock bumpers, submersible bumpers, architectural features, facades, coverings, screens, motors, turrets, electrical switches, reed switches, position digitizers, position encoders, and combinations thereof.

9. A composite comprising:
a substrate; and
the nanocomposite of claim 1 bonded to the substrate.

10. The composite of claim 9, wherein the substrate is selected from the group consisting of transition metals, copper, iron, stainless steel, concrete, porous materials, wood, cardboard, aluminum, pretreated aluminum, density polyethylene (LDPE), and combinations thereof.

11. The composite of claim 9, wherein the composite does not comprise a bonding agent.

12. A method of producing a nanocomposite, the method comprising:
forming a mixture comprising:
a resin polymer or a resin monomer;
magnetite nanoparticles;
optionally further nanoparticles; and
optionally a filler;
wherein the magnetite nanoparticles are present in the nanocomposite in an amount of at least 10% by volume;
mixing the mixture;
optionally heating the mixture;
providing the mixture to a mold or surface; and
curing the mixture.

13. The method of claim 12, wherein the method step of mixing the mixture comprises mixing the mixture with a non-contact magnet.

14. The method of claim 12, wherein the method step of mixing the mixture polymerizes the resin monomer.

15. The method of claim 12, wherein the method step of heating the mixture comprises heating the mixture to a temperature in a range of from about 35° C. to about 65° C.

16. The method of claim 12, wherein the method step of providing the mixture to a mold or surface comprises providing the mixture to a portion of a conducting surface, wherein the mixture distributes itself across the conducting surface.

17. The method of claim 12, wherein the method step of providing the mixture to a mold or surface comprises providing the mixture to a portion of a surface and selectively distributing the mixture across the surface with a magnet.

18. The method of claim 12, wherein the method step of curing the mixture comprises curing the mixture for a time in a range of from about 1 hour to about 96 hours.

19. A method of using a nanocomposite comprising:
a resin;
magnetite nanoparticles;
optionally further nanoparticles; and
optionally a filler;
wherein the magnetite nanoparticles are present in the nanocomposite in an amount of at least 10% by volume,
the method comprising using the nanocomposite to form a product selected from the group consisting of composite materials, ballistic materials, ballistic doors, equipment housings, sonar equipment housings, concretes, cements, pipes, optical systems, lasers, lights, spotlights, solar panels, flooring panels, clips, docks, dock bumpers, submersible bumpers, architectural features, facades, coverings, screens, motors, turrets, electrical switches, reed switches, position digitizers, position encoders, and combinations thereof.

20. The method of claim 19, wherein the method step of using the nanocomposite improves a property of the product selected from the group consisting of impact resistance, ballistics resistance, heat absorption, radiation absorption, radiofrequency shielding, magnetic field shielding, luminescence, and combinations thereof.
